(19) United States
(12) Patent Application Publication
(10) Pub. No.: US 2014/0202339 A1
(43) Pub. Date: Jul. 24, 2014

(54) VERTICAL CONVEYOR OVEN WITH ADVANCED AIRFLOW

(71) Applicant: Avantec, LLC, Des Plaines, IL (US)

(72) Inventors: James T. Cole, Algonquin, IL (US); David R. Goble, Schaumberg, IL (US)

(73) Assignee: Avantec, LLC, Des Plaines, IL (US)

(21) Appl. No.: 14/056,933

(22) Filed: Oct. 17, 2013

Related U.S. Application Data
(60) Provisional application No. 61/715,077, filed on Oct. 17, 2012.

(51) Int. Cl. A47J 37/04

(52) U.S. Cl. CPC A47J 37/045
USPC 99/443 C

(57) ABSTRACT

A conveyor oven is disclosed comprising a cooking chamber, thermal heating source, conveyor means and top and bottom airflow within the cooking chamber wherein substantial uniformity of the cooking of food in the convection oven is achieved. Specifically, the apparatus and methods of the present invention provide for moving food through a first heated section with one particular heat and airflow, then through a second section with an air flow in the opposite direction wherein the oven can produce a very high volume of food that is evenly baked.

### CROSS-REFERENCE TO RELATED APPLICATIONS

This application claims the benefit of priority of Application Provisional Application Ser. No. 61/715,077 entitled “VERTICAL CONVEYOR OVEN WITH ADVANCED AIRFLOW”, filed Oct. 17, 2012, the contents of which are hereby incorporated by reference in their entirety.

### BACKGROUND OF THE INVENTION

1. Field of the Invention

The field of art disclosed herein pertains to an oven having a conveyor means for moving food through a first heated section with a first heat source and airflow and then through a second heated section with a second heat source and airflow in the opposite direction wherein the oven can produce a very high volume of food that is evenly baked.

2. Description of the Related Art

As food is cooked in an oven, the hottest air leaves outlet vents of the heater/blower area. The air then transfers heat to the food products being cooked and consequently cools down as a result. This cooler air is then return to the blower/heater area to reheat and recycle.

Generally the position of the food being cooked in a convection oven remains stationary relative to the airflow through the cooking period. As a result, parts of product that are in the oven see the hottest air while other parts see the cooler air throughout the cooking time. The parts the see the hotter air frequently become overcooked (darker and more dried out). The parts that see the cooler air can remain undercooked.

Some alternate airflow schemes have been developed that try to compensate for this deficiency by actively changing the airflow pattern while the food is in the cavity. While this may improve the situation, the apparatus needed to accomplish this are complicated and difficult to maintain in a commercial kitchen environment.

Accordingly, there is a need for an oven that can produce a very high volume of food that is evenly baked.

[symbol]

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 depicts an oven complete with the outer skin, which houses the internal components and the insulation.

FIG. 2 is a front view of the oven showing a control module on the top and a pizza on a pan inside the oven.

FIG. 3 is a front isometric partially exploded view of the oven of FIG. 1.

FIG. 4 is a front partially exploded isometric view of a heating assembly.

FIG. 5 is a rear isometric side view of the internals of the oven showing the heating assembly nested within the conveyor assemblies of FIG. 3.

FIG. 6 is a front partial view of the oven internals showing the left and right conveyor drives with the left and right duct assemblies and the direction of air flow in the upper and lower portions of the oven.

FIG. 7 is a rear view of the complete oven of FIG. 1 showing a chain drive that powers the left and right conveyors of FIG. 5.

FIG. 8 is a section view of the right side of the oven.

[symbol]

### DETAILED DESCRIPTION

The present innovation relates generally to devices and methods for use in cooking food products. Provided is an oven having a conveyor means for moving food through a first heated section with a first heat source and airflow and then through a second heated section with a second heat source and airflow in the opposite direction wherein the oven can produce a very high volume of food that is evenly baked.

At the start of the day, the oven will be preheated to ready to cook conditions. The oven temperature and the cook time will be set on the controls based on the product to be cooked. When the operator is ready, product will be inserted into the upper slot. The product will pass down into the first airflow stream, and then continue through the second airflow stream. The product will then exit the bottom slot. Products that are cooked will experience one of three situations:
Product on the right side of the oven may see the hottest air first and then the cooler air second.
Product on the left side of the oven may see the cooler air first and then the hottest air second.
Product in the middle of the oven (side to side) will always see an intermediate temperature.

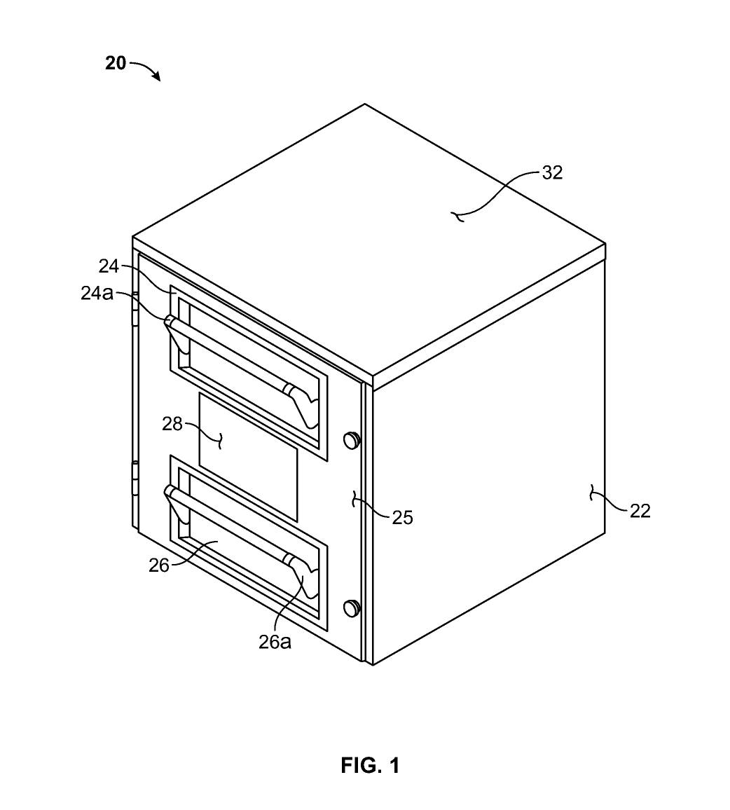

In this manner, all products will be well cooked. With initial reference to FIGS. 1-6 conveyor oven includes exterior front wall, exterior right side wall, exterior left side wall, exterior back wall, exterior bottom wall and exterior top wall. Food products, not shown, are transported into and through cooking chamber by conveyor. In one embodiment, the conveyor assembly comprises a continuous conveyor which extends from entrance opening and exit opening. The width of conveyor allows for placement of trays. In one embodiment, the trays are removable.

The conveyor oven may be supported by legs, movable by rollers or both. In addition, the oven may sit on a support base, shelf or table top, or be stacked one above another.

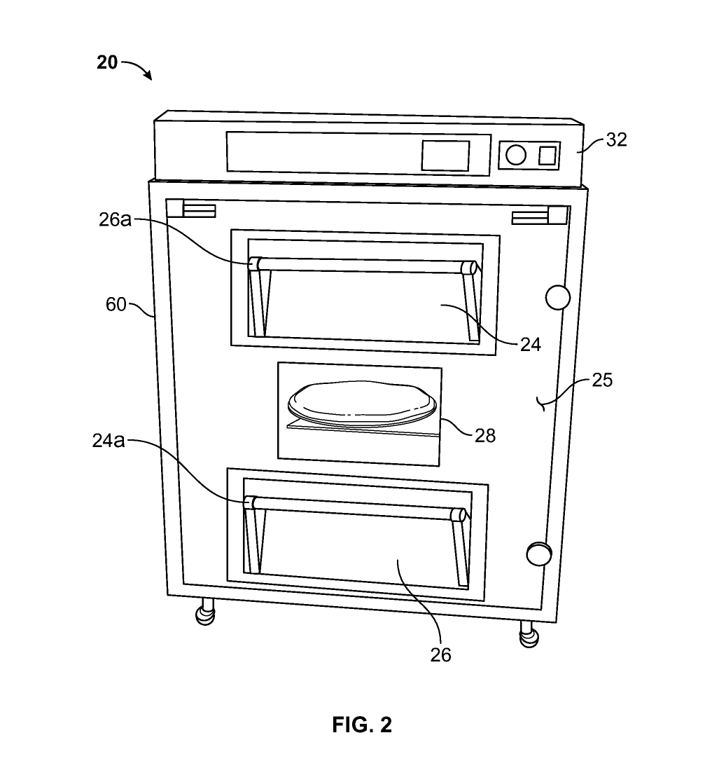

FIG. 1 shows one embodiment of an oven 20 of the present invention complete with the outer skin 22, which houses the internal components and the insulation. In typical use, food product is inserted into the oven through the top slot 24 (shown on the oven front). The top slot can include a top door 24a mounted within a main door 25. The cooked product exits at the bottom through a bottom slot 26 which can include a bottom door 26a mounted in the main door 25. A window 28 can be provided for viewing the food. Products may be placed on a tray or rack so that multiple products may be at anyone vertical position. A top 30 can be provided for food placement or for a control module 32 as shown in FIG. 2

FIG. 2 is a front view of the oven of FIG. 1 showing the control module 32 mounted on the top 30. The control module 32 can offer temperature controls, conveyor speed controls, and different settings that may be required to cook different types or thicknesses of food. The conveyor movement downward through the cavity may be continuous or indexing (where the movement will be multiple small rapid moves followed by a period of stationary positioning. The airflow for the indexing movement may be designed to maximize the airflow directed at the top and bottom of the product to enhance the speed of cook by changing the position of the air holes in the ducts. The airflow temperature of the top and bottom duct outlets may be set independently to adjust for buoyancy effects. The volume of air delivered from the top and bottom duct outlets may be set independently to adjust for buoyancy effects. Instead of exiting through a bottom slot, the product may enter a holding cabinet that is attached to the oven bottom. As additional products are cooked, the holding cabinet will index down to accommodate the next product. Oven operators can the access the hot cabinet to remove the desired products.

The gas flow within the conveyor oven, as well as other functions of cooking appliance are directed by the control module 32. The c control module 32 determines, among other things, the velocity of gas flow, which may be constant or varied, or, may be constantly varied throughout the cooking cycle. It may be desired to cook the food product on one velocity throughout the entire cooking cycle, or to vary the gas velocity depending upon conditions such as a pre-determined cooking recipes, or vary the gas velocity in response to various sensors that may be placed within the cooking zone, oven return gas paths or various other positions within the oven. The location and placement of said sensors will be determined by the particular application of the oven. Additionally, other means may be utilized wherein data is transmitted back to the controller, and thereafter the controller adjusts the cooking recipe in an appropriate manner. For example sensors (temperature, humidity, velocity, vision and gas borne chemical mixture level sensors) may be utilized to constantly monitor the cooking conditions and adjust the gas flow, and other sensors not described herein may also be utilized and the cooking conveyor oven may utilize sensors that are not currently commercially practical due to cost or other limitations (such as laser, non-invasive temperature sensors, IR sensors and laser to locate the sensed area and other sensors that are currently too expensive to be commercially feasible), and the oven is not limited to those discussed herein, as many sensing devices are known and utilized in and applicant intends to encompass within the language any structure presently existing or developed in the future that performs the same function.

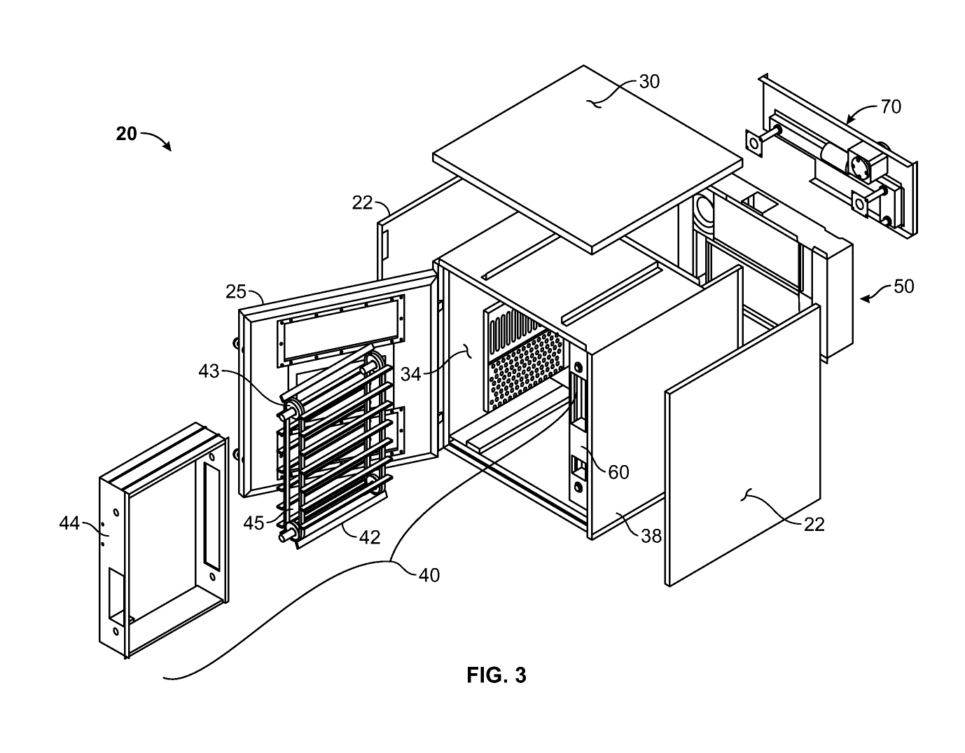

FIG. 3 is a rear side view one embodiment of part of the internal components of an oven 20 of the present invention. The previously described outer skins 22 and top mount onto a hollow chamber assembly 38. The chamber assembly 38 include a left conveyor assembly 40 mounted within the chamber assembly on the left side and a right conveyor assembly 60 mounted within the chamber assembly 38 on the right side to move pans 80 from top to bottom within the oven 20. The left conveyor assembly 40 is shown exploded and the right conveyor assembly 60 is shown assembled and mounted within a cooking chamber 34 of the oven 20. The left conveyor assembly 40 comprises a conveyor belt 42 that rotates vertically around a pair of shafts 43 that mount into a conveyor frame 44. A central slot 45 is located within the conveyor belt 42.

A heating assembly 50 mounts within the chamber assembly 38 from the rear to blow warm convection oven air from side to side within the chamber assembly. A drive assembly 70 mounts at the rear of the oven to drive the left conveyor assembly 40 and the right conveyor assembly 60.

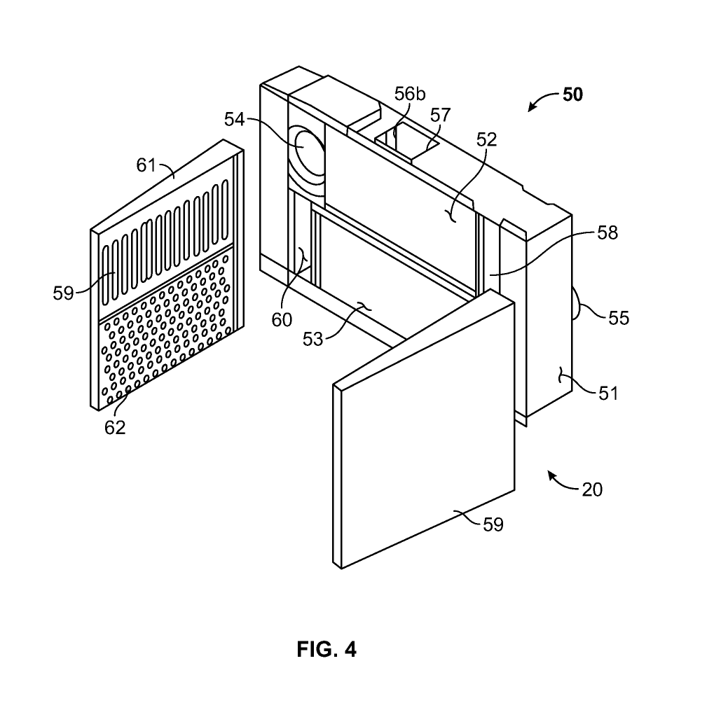

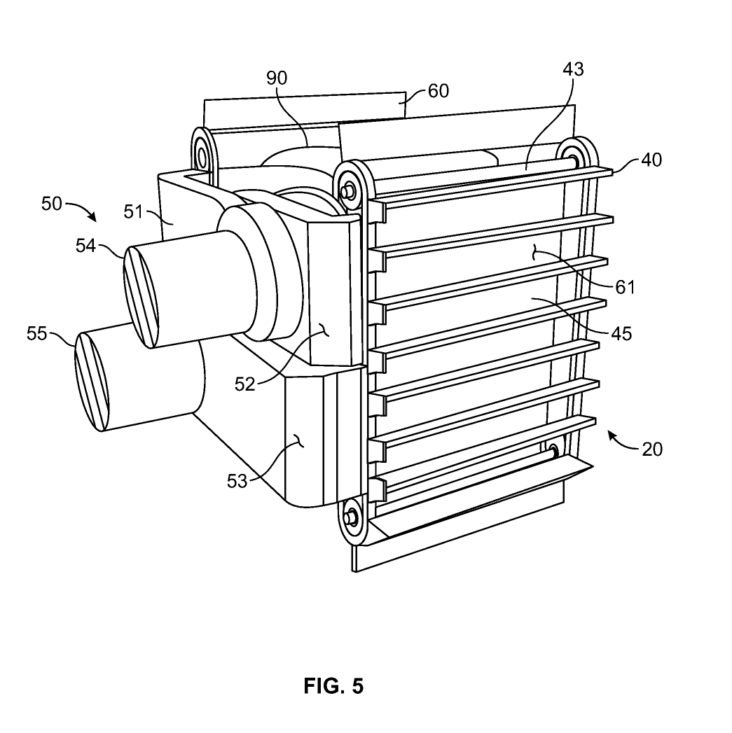

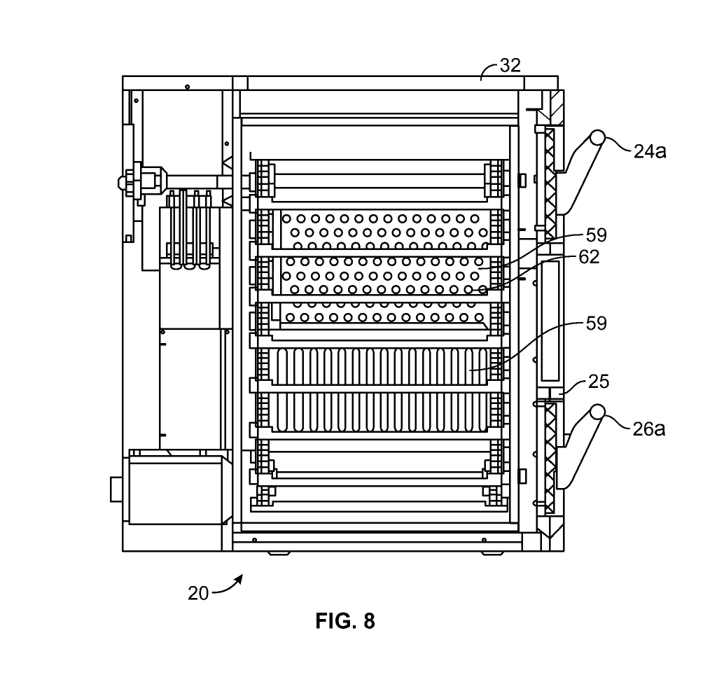

As best shown in FIG. 4, and FIGS. 2 and 5, the heating assembly 50 can comprise a hollow blower unit 51 that is divided into an upper portion 52 and a lower portion 53. A left blower 54 attaches the upper portion 52, and a heater 56 mounts within as seen through an intake 57. A right blower 55 attaches to the lower portion 53 and also includes a heater 56 and an intake 57 on the bottom of the hollow blower unit 51. A left duct 61 attaches to the left side of the hollow blower unit 51 and includes a plurality of slots 59 in the top to vent convection air thereform. A plurality of holes 62 are located in the in the bottom of the left duct 61. The right duct 59 is a mirror of the left duct 61 with the slots 59 on the bottom and the holes 62 on the top (see FIG. 8).

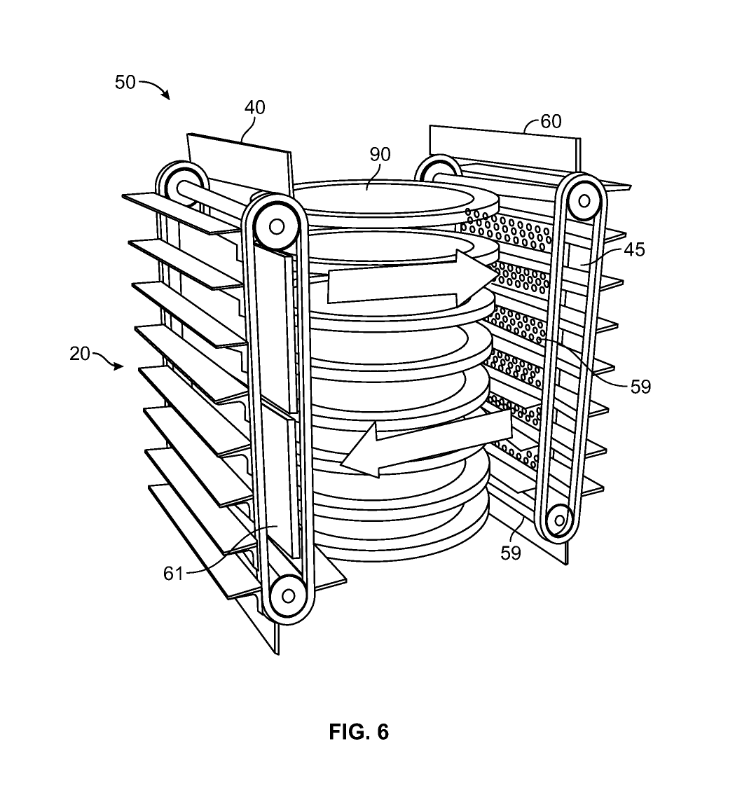

As shown in FIG. 6, at the top of the oven 20, convection air exits from the slots 59 in the top of the left duct 61 and enters the holes in the top of the right duct 59. At the bottom of the oven 20, the convection air exits from the slots 59 in the bottom of the right duct 59 and enters the holes in the bottom of the left duct 61. Thus, the upper portion of the oven has convection flow from left to right, and the lower portion has convection flow from right to left.

In one embodiment, the heater 56 of the conveyor oven is comprised of two independently controlled gas transfer systems, described herein as a first gas transfer system 56a and a second gas transfer system 56b and although the first and second gas transfer systems 56a, 56b are described as identical, it is not required that they be identical. Described herein in detail is the first gas transfer system 56a. The bottom system is made, functions and operates in the same manner as the top system. Alternately, heating coils can be used.

The term “gas” refers to any fluid mixture, including air, nitrogen and other mixtures that may be used for cooking, and applicant intends to encompass within the language and meaning any gas or gas mixture existing or developed in the future that performs the same function. Additionally, the term “airflow” refers to, and includes gas flow.

First gas delivery system 56a of FIG. 4 delivers temperature-controlled gas to the top side of food product and second gas delivery system 56b delivers gas to the bottom side of the food product. Independent control of top and second gas transfer systems is known and further described in U.S. Pat. Nos. 5,568,802, 5,717,192, 6,517,882, and 6,716,467.

Turning now to FIGS. 5 and 6, the heating assembly 50 of FIG. 4 is show with the left duct 60 nested into the central slot 45 of the left conveyor assembly 40 and the right duct 59 nested within the central slot 45 of the right conveyor assembly 60. Pans 90 can be seen supported between the left conveyor assembly 40 and the right conveyor assembly 60, and can be moved from top to bottom by the conveyors 40, 60. As descried previously and best shown in FIG. 6, the upper portion of the oven has convection flow from left to right, and the lower portion has convection flow from right to left

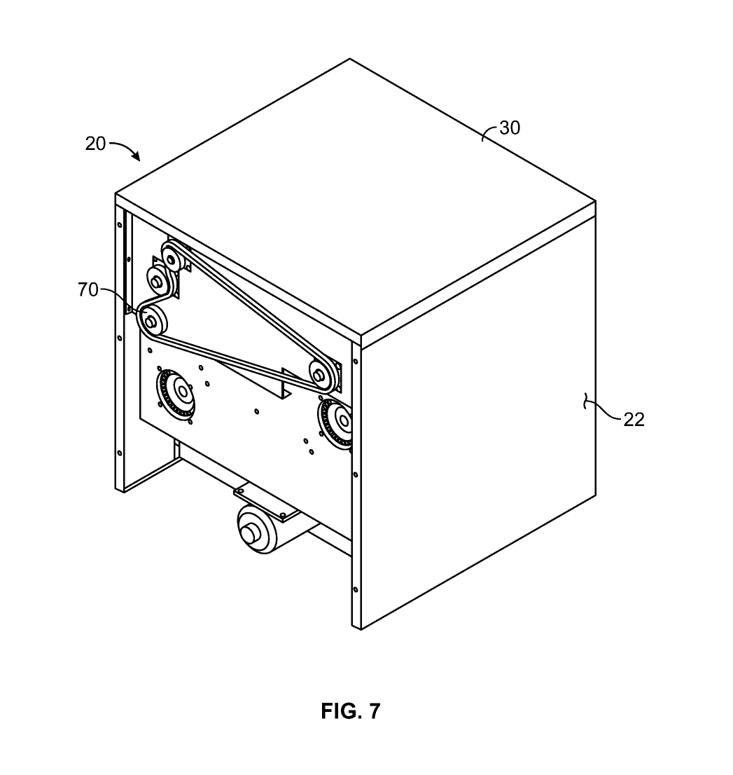

FIG. 7 shows a rear view of the oven 20 and the drive assembly 70 mounts at the rear of the oven to drive the left conveyor assembly 40 and the right conveyor assembly 60.

In one embodiment, portions of oven are cooled by one or more cooling duct wherein fresh air is drawn through intake opening and distributed throughout oven as required.

In one embodiment, the first and second gas supply systems are the same configuration and function to uniformly circulate hot gas flow to the top and bottom sides of food product upon the conveyor, and return the gas to the gas heating means for re-delivery to the cooking chamber.

The number and placement of the apertures will vary according to the particular oven that is desired. For example, a general purpose conveyor oven may be scaled to a baking oven by changing the number of apertures, which may be fewer in number but be larger in size, thereby allowing for a more gentle gas flow across the food product, and producing proper delicate baking of the food product. If a browning oven were desired, the apertures may be more numerous and smaller in diameter.

Although the first gas flow system has been described in detail, the second gas system functions in the same manner.

Although the exemplary embodiment illustrates the use of a two blower design with one blower providing the gas flow to the top of the cooking cavity and a second blower for gas flow to the bottom of the cooking cavity, one gas flow means may be utilized, or more than two gas flow means may be utilized and applicant intends to encompass within the language any structure presently existing or developed in the future that performs the same function.

Although one version present invention has been described in considerable detail with reference to certain preferred versions thereof, other versions are possible. For example, various sizes of conveyor ovens may be made. In these cases larger or smaller component parts may be utilized, and fewer or more components may be employed. In the case where it is desirable to make a smaller conveyor oven, one gas flow acceleration means may be utilized instead of two; smaller or fewer thermal gas devices may be used.

To summarize, the present invention provides for a conveyor oven utilizing hot gas flow, supplied from combustion energy in order to achieve faster cooking of food products. The conveyor oven is simple and economical to manufacture, use and maintain, and is directly scalable to larger or smaller embodiments.

All publications, patents and patent applications cited herein, whether supra or infra, are hereby incorporated by reference in their entirety to the same extent as if each individual publication, patent or patent application was specifically and individually indicated as incorporated by reference. It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

What is claimed is:

1. A convection oven for cooking food with convected air comprising:
a cooking chamber having an upper food insertion slot and a lower food removal slot;
a conveyor system within the oven for moving food on a pan from the upper food insertion slot to the lower food removal slot;
a heater attached to the cooking chamber to heat the convection air;
a first duct on a first side of the cooking chamber having at least one upper opening configured to vent convection air therefrom onto the food, and at least one lower opening in the first duct configured for receiving convection air therein passed over the food; and
a second duct on an opposite side of the cooking chamber having at least one upper opening configured for receiving convection air therein passed over the food and at least one lower opening therein configured to vent convection air therefrom onto the food,
wherein the flow of convection air across the top of the oven is from the first duct to the second duct and the flow of convection air in the bottom of the oven is from the second duct to the first duct.
